(19) United States
(12) Patent Application Publication
(10) Pub. No.: US 2026/0195160 A1
(43) Pub. Date: Jul. 9, 2026

(54) DATA INTEGRATION WHICH SUPPORTS FUNCTION VIRTUALIZATION

(71) Applicant: INTERNATIONAL BUSINESS MACHINES CORPORATION, Armonk, NY (US)

(72) Inventors: Chang Sheng Liu, Beijing (CN); Hai Jun Shen, Tianjin (CN); Yan Li Xu, BEIJING (CN); Lei Cui, BEIJING (CN); Jun Hui Liu, BEIJING (CN); Xue Huang, BEIJING (CN)

(21) Appl. No.: 19/013,835

(22) Filed: Jan. 8, 2025

(51) Int. Cl. G06F 9/455

(52) U.S. Cl. CPC G06F 9/45558

(57) ABSTRACT

Embodiments receive at least one function of a remote data source; create a virtual function for the at least one function; invoke the virtual function to determine a result of the at least one function in response to the virtual function having a different source than a source of input data; optimize performance of the virtual function; and output the result of the at least one function.

### BACKGROUND

Aspects of the present invention relate generally to a system and a method for data integration which supports functional virtualization.

When utilizing big data, distributed systems have been widely adopted to handle large volumes of data. In particular, data virtualization systems are configured to enable integration of data from multiple sources, which allow users to access diverse sources without knowing a physical location of these diverse sources.

### SUMMARY

In a first aspect of the invention, there is a computer-implemented method including: receiving, by a processor set, at least one function of a remote data source; creating, by the processor set, a virtual function for the at least one function; invoking, by the processor set, the virtual function to determine a result of the at least one function in response to the virtual function having a different source than a source of input data; optimizing, by the processor set, performing of the virtual function; and outputting, by the processor set, the result of the at least one function.

In another aspect of the invention, there is a computer program product including one or more computer readable storage media and program instructions stored on the one or more computer readable storage media to perform operations including: receiving at least one function of a remote data source; creating a virtual function for the at least one function; invoking the virtual function to determine a result of the at least one function in response to the virtual function having a different source than a source of input data; optimizing performing of the virtual function; and outputting the result of the at least one function.

In another aspect of the invention, there is a system including a processor set, one or more computer readable storage media, and program instructions stored on the one or more computer readable storage media to cause the processor set to perform operations including: receiving at least one function of a remote data source; creating a virtual function for the at least one function; invoking the virtual function i to determine a result of the at least one function in response to the virtual function having a different source than a source of input data; optimizing performing of the virtual function; and outputting the result of the at least one function. Embodiments include the virtual function being mapped to a company function and the data resides in another company database.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

FIG. 5 shows a flowchart of an exemplary method in accordance with aspects of the present invention.

### DETAILED DESCRIPTION

Aspects of the present invention relate generally to a system and a method for data integration which supports functional virtualization. Embodiments of the present invention provide a system, a computer program product, and a computer-implemented method for enabling function virtualization within a data virtualization system to allow processing of data from multiple sources. In particular, aspects of the present invention provide a system, a computer program product, and a computer-implemented method to enhance an existing data virtualization architecture by introducing virtual functions that allow cross-source computations. In further aspects of the present invention, the computer-implemented method enables broad integration and enhances computational flexibility in a distributed environment. Embodiments of the present invention enable virtualization of functions and allow functions from one source to be utilized with a data virtualization system to process data from any source. In further embodiments of the present invention, a data virtualization system virtualizes functions to allow processing of data from a plurality of sources.

Embodiments of the present invention process data from a plurality of sources in a data virtualization system regardless of a source of a function. Embodiments of the present invention create a virtual function which can be invoked to provide computational efficiency across various sources. Embodiments of the present invention improve cross-source data integration and computational flexibility.

Embodiments of the present invention provide cross-source functional virtualization to decouple function execution from a data source of a function. Implementations of the present invention allow functions within a data virtualization system to operate or execute on data from sources which are different from an original source of the functions. Aspects of the present invention provide a unified computational layer where both data and computations can be virtualized and accessed transparently by utilizing function virtualization. Implementations of the present invention reduce a complexity of managing and integrating multiple data sources.

Aspects of the present invention optimize cross-source function invoking through array binding to significantly reduce a performance bottleneck associated with large datasets. Embodiments of the present invention allow for efficient batch processing of input data for remote function calls. Further embodiments of the present invention provide for a virtual function architecture which is designed to be modular and scalable. Implementations of the present invention support an increasing number of data sources and functions and make a data virtualization system adaptable to a complex distributed data environment.

Embodiments of the present invention ensure that virtual functions can be invoked and executed on remote data sources. Further, aspects of the present invention enhance flexibility for complex structured query language (SQL) queries. Implementations of the present invention apply complex analytic functions defined on one database to data stored in other databases to enable comprehensive reporting and insights for cross-database analytics.

Aspects of the present invention leverage virtual functions to create unified views and perform computations across diverse datasets within heterogenous data environments to perform multi-source data integration. Embodiments of the present invention virtualize functions used in data science models (e.g., user-defined functions for feature extraction or transformation) to allow seamless integration across data sources in machine learning (ML) pipelines. Implementations of the present invention offer a robust, flexible, and scalable solution to enable computations across distributed, multi-source environments in data virtualization systems.

Embodiments of the present invention virtualize functions in a data virtualization system. For example, a computer-implemented method includes: creating a virtual function with a data virtualization server; mapping the virtual function to a remote function in a predetermined data source; and enabling the virtual function to process data from multiple data sources by invoking the remote function regardless of where an input data is stored. The computer-implemented method further includes the virtual function allowing co-located data from a same source as a function as a function to be processed through remote invoking. The computer-implemented method also includes the virtual function allowing data from a different source than the function to be processed to enable cross-source computation. The computer-implemented method further includes improving performance by batching data into a plurality of arrays to reduce a number of required function calls. The computer-implemented method also includes integrating computation and data retrieval from multiple sources into a single seamless process.

Conventional distributed systems only perform operations on data from a same source as a source of a function. As a non-limiting, example, the function comprises a user defined function for feature extraction in a data science model application. In an example of a conventional distributed system, a function from a first company database cannot process data from a second company source, which is different from the first company database. Accordingly, conventional systems have limitations which restrict the computational scope and integration capabilities of the data utilization system. In other words, conventional systems restrict functions to their respective data source. In contrast, embodiments of the present invention provide a computer-implemented method, a system, and a computer program product for enabling virtualization of functions which allow functions from one source to process data from any data source within a data virtualization system. Embodiments of the present invention introduce a layer of functional abstraction which allows functions defined in one data source to be processed and applied to another data source. Further, aspects of the present invention improve flexibility, efficiency, and cross-source computation within a distributed data virtualization system.

Embodiments of the present invention include a system, method, and computer program product for virtualizing functions within a data virtualization system to allow processing of data which is different from a source of a data source function. Accordingly, implementations of the present invention provide an improvement (i.e., technical solution) to a problem arising in the technical field of distributed systems. In particular, embodiments of the present invention enable integration and enhancement of computational flexibility in the data virtualization system.

Implementations of the present invention are necessarily rooted in computer technology. For example, the steps of creating a virtual function for at least one function and invoking the virtual function to determine a result of the at least one function in response to the virtual function having a different source than data cannot be performed in the human mind (or with pen and paper). Creating a virtual function for the at least one function and invoking the virtual function to determine a result of the at least one function in response to the virtual function having a different source than data is, by definition, performed by a computer and cannot be performed in the human mind (or with a pen and paper) due to the complexity and amounts of calculations involved in creating and invoking the virtual function for large datasets.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as function virtualization code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

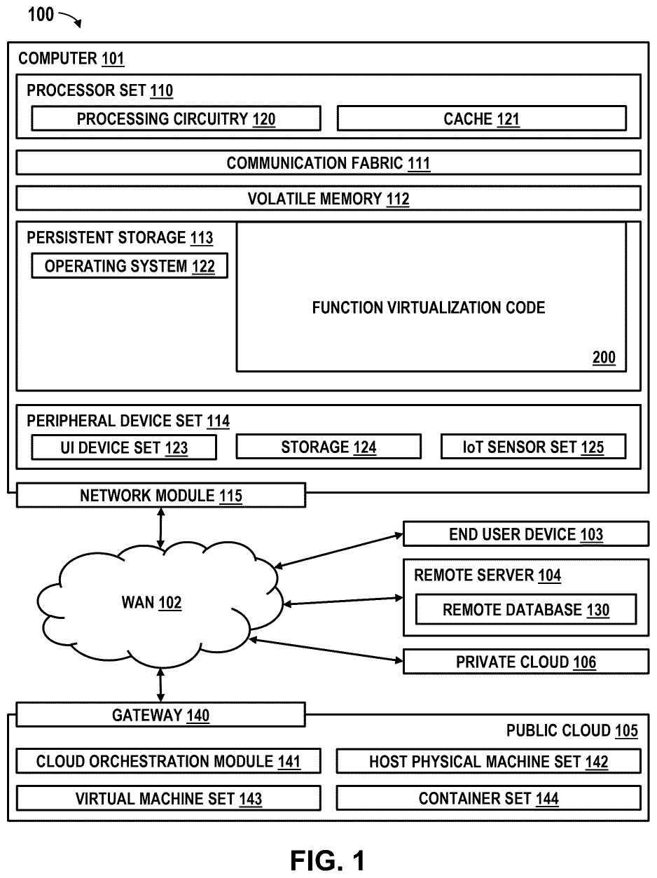

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

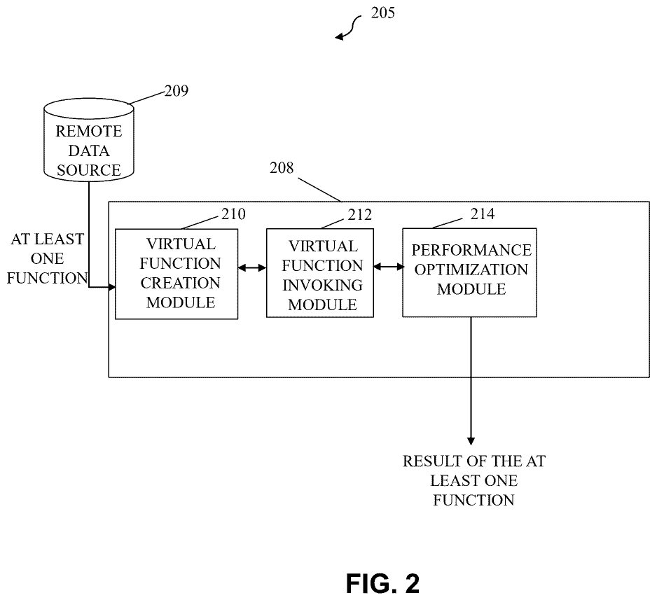

FIG. 2 shows a block diagram of an exemplary environment 205 in accordance with aspects of the present invention. In embodiments, the environment 205 includes a function virtualization server 208, which may comprise one or more instances of the computer 101 of FIG. 1. In other examples, the function virtualization server 208 comprises one or more virtual machines or one or more containers running on one or more instances of the computer 101 of FIG. 1. In embodiments, the functional virtualization server 208 manages connections to a remote data source 209 and functions across the connected sources. The environment 205 may also include the remote data source 209, which is external to the function virtualization server 208. In an example, the remote data source 209 comprises one or more instances of the remote database 130 of FIG. 1. In further aspects of the present invention, the remote data source 209 may include a company database.

In embodiments, the function virtualization server 208 of FIG. 2 comprises a virtual function creation module 210, a virtual function invoking module 212, and a performance optimization module 214, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The function virtualization server 208 may include additional or fewer modules than those shown in FIG. 2. In embodiments, separate modules may be integrated into a single module. For example, the virtual function creation module 210 and the virtual function invoking module 212 may be included in a function virtualization layer that handles the creation and invoking of virtual functions and abstracting function execution across distributed data sources. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In embodiments, the virtual function creation module 210 receives at least one function from the remote data source 209. As disclosed above, a non-limiting example of at least one function comprises a feature extraction from a data source model application. In further embodiments, the remote data source 209 comprises at least one database which includes the at least one function. In embodiments of the present invention, the at least one function within the remote data source 209 is accessible via mappings created by the function virtualization server 208. In aspects of the present invention, the virtual function creation module 210 creates a virtual function corresponding to the at least one function. In an example, the virtual function creation module 210 creates the virtual function using the syntax below:

| CREATE VIRTUAL FUNCTION <local_schema>, | |
|---|---|
| <local_function_name> | |
| FOR <server>, <remote_schema>, <remote_function_name> | |
| [OPTIONS (OPTION_NAME1 VALUE1 ....)] | (Syntax 1). |

In the Syntax 1 above, the <local_schema> specifies a schema for a virtual function in the function virtualization server 208. In further embodiments, the <local_function_name> specifies a name of the function in the function virtualization server 208. In aspects of the present invention, the <server> specifies a remote data source mapping and is created using an existing CREATE SERVER data definition language (DDL). In embodiments of the present invention, the <remote_scheme> and <remote_function_name> refer to the schema and function names, respectively, in the remote data source. In further embodiments of the present invention, OPTIONS refer to additional properties for the virtual function. In aspects of the present invention, the virtual function creation module 210 creates the virtual function to allow users to define functions in one data and reference the data source when processing data from any source in the system. In embodiments of the present invention, virtual function acts as an abstraction layer between local queries and remote data source functions. In further embodiments of the present invention, the virtual function creation module 210 creating the virtual function reduces redundancy and allows function logic to be maintained in a single source. In further embodiments, the virtual function is a local interface in the function virtualization server 208 and can be referenced in structured query language (SQL) queries. The virtual function creation module 210 sends the created virtual function to the virtual function invoking module 212.

In embodiments, the virtual function invoking module 212 receives the created virtual function and processes data from different sources. In aspects of the present invention, the created virtual function can be referenced in SQL queries. In further embodiments, the virtual function invoking module 212 performs a remote function invoking at a same source in response to the virtual function and the data residing in the same source. In an example, the virtual function invoking module 214 translates the SQL query in response to the virtual function and the data residing in the same source. In particular, a virtual function vfun1 is mapped to a company function ora_fun1 and the data also resides in a company database (via a virtual table vt_table1) mapped to a company table (e.g., ora_table1). In this scenario, the virtual function invoking module 214 translates a first SQL query below into a translated SQL query as shown below in response to the virtual function and the data residing in the same source:

| | |
|---|---|
| SELECT vfun1(c1) FROM v1_table1 | (First SQL query). |
| SELECT ora_fun1(c1) FROM ora_table1 | (TRANSLATED SQL). |

In further embodiments, the virtual function invoking module 212 processes the virtual function vfun1 by translating the virtual function vfun1 based on the virtual function and the data residing in the same source. In this scenario, the function and the data are residing in the same source (e.g., co-located in the same source). In embodiments, the function virtualization server 208 sends the translated virtual function to the company database for execution. Accordingly, the function virtualization server 208 benefits from native pushdown optimizations due to the function and the data being co-located in the same source. The virtual function invoking module 212 sends the translated virtual function to the performance optimization module 214.

In further embodiments of the present invention, the virtual function invoking module 212 integrates the virtual function from one source with data from another source in response to the virtual function having a different source than the data. In particular, a virtual function vfun1 is mapped to a company function ora_fun1 and the data resides in another company database (via a virtual table vt_table2) mapped to another company table (e.g., mysql_table1). In another example, the virtual function invoking module 212 integrates the virtual function from one source with the data from another in response to the virtual function having the different source than the data as shown below:

| SELECT vfun1(c1) FROM v1_table1 | | (First SQL query). |
|---|---|---|
| 1. | Retrieve data (i.e., c1) from the first SQL query | (First Workflow |
| | | Process). |
| 2. | Pass the retrieved data (e.g., c1) as input parameters to a company | |
| | database associated with the company function | (Second Workflow |
| | | Process). |
| 3. | Return a function result from the company database based on the | |
| | retrieved data | |
| | | (Third Workflow |
| | Process). | |

In further embodiments, the virtual function invoking module 212 integrates the virtual function from the first SQL query with the data by retrieving the data from the first SQL query, passing the retrieved data as input parameters to the one source (e.g., a company database) of the virtual function, and returning a function result of the one source (e.g., the company database). In aspects of the present invention, the virtual function invoking module 212 sends the function result to a user of the function virtualization server 208. In further aspects of the present invention, the virtual function invoking module 212 sends the function result to the performance optimization module 214.

In aspects of the present invention, the virtual function invoking module 212 performs a query parsing in which a user submits a SQL query involving a virtual function and a virtual table that come from different sources, as shown below:

| | |
|---|---|
| SELECT vfun1(c1) FROM v2_table2 | (Second SQL query). |

In embodiments and as described above with the second SQL query, vfun1 is mapped to the company function ora_fun1 and vt_table2 is mapped to another company table (e.g., msql_table1). The virtual function invoking module 212 also performs a data retrieval in which the virtual function invoking module 212 retrieves the data from the another company table (e.g., msql_table1). The virtual function invoking module 212 then binds the retrieved data as input parameters to the company database for the company function (e.g., ora_fun1), as shown below:

| | |
|---|---|
| SELECT ora_fun1(?) from dual | (Bind Retrieved Data). |

In further embodiments and as described above with the binded retrieved data, the company database returns the function result, which is then aggregated with the data of a database management system (e.g., mySQL) in the virtual function invoking module 212. The virtual function invoking module 212 sends the aggregated function result to a user as a final result of the query and sends the function result to the performance optimization module 214.

In aspects of the present invention, the performance optimization module 214 receives at least one of the function result and the translated virtual function from the virtual function invoking module 212. In embodiments, the performance optimization module 214 batches rows into arrays and sends the arrays of values as input parameters to a single query for the remote function invoking in the virtual function invoking module 212. Accordingly, implementations of the present invention reduce an overhead of individual function calls for each row of data. Accordingly, the performance optimization module 214 utilizes an array-based approach which minimizes iterations and improves performance of remote function calls and execution time of large datasets. In further embodiments, the performance optimization module 214 utilizes a size of a data block used for the array of values to determine how many rows to batch at once. In aspects of the present invention, the buffer size of the data block can be configured by a user or an administrator. In other aspects of the present invention, the buffer size of the data block can be automatically selected based on system resources and business performance requirements. In embodiments, the performance optimization module 214 outputs a result of the at least one function. In further embodiments, the performance optimization module 214 reduces network overhead by passing the array of values in the single call.

In embodiments of the present invention, the performance optimization module 214 batches the rows into arrays as shown below:

| 1. | Fetching data (e.g., 1000 rows) from the database management | |
|---|---|---|
| | system (e.g., MySQL) | |
| | | (First Workflow Process). |
| 2. | Batches the rows into an array of values for the company database. | |
| | | (Second Workflow Process). |
| 3. | Passing the array of values in a single call as an input parameter | |
| | to the company function | (Third Workflow Process). |

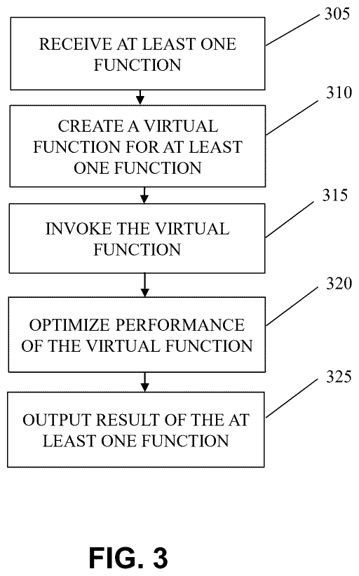

FIG. 3 shows a flowchart of an exemplary method in accordance with aspects of the present invention. Steps of the method may be carried out as operations in the environment 205 of FIG. 2 and are described with reference to elements depicted in FIG. 2.

At step 305, the system receives, at the virtual function creation module 210, at least one function from a remote data source 209. In embodiments and as described with FIG. 2, the remote data source 209 comprises at least one database which includes the at least one function. At step 310, the system creates, at the virtual function creation module 210, a virtual function corresponding to the at least one functional. In embodiments and as described with FIG. 2, the virtual function acts as an abstraction layer between local queries and remote data source functions.

At step 315, the system invokes, at the virtual function invoking module 214, the virtual function. At step 320, the system optimizes, at the performance optimization module 214, performance of the virtual function by batching rows into arrays in a single query. In embodiments and as described with FIG. 2, the virtual function invoking module 214 optimizes performance of the virtual function by batching rows into arrays in a single query for the remote invoking in the virtual function invoking module 212. At step 325, the system outputs, at the virtual function invoking module 214, a result of the at least one function.

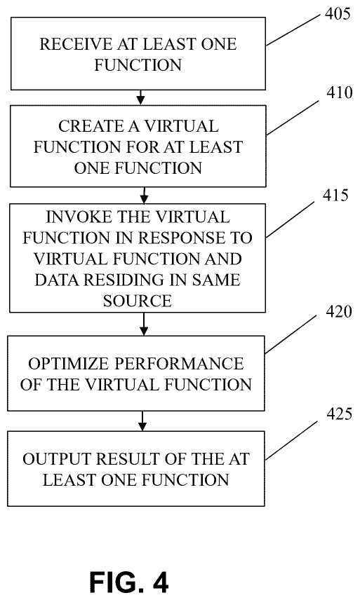

FIG. 4 shows a flowchart of an exemplary method in accordance with aspects of the present invention. Steps of the method may be carried out as operations in the environment 205 of FIG. 2 and are described with reference to elements depicted in FIG. 2.

At step 405, the system receives, at the virtual function creation module 210, at least one function from a remote data source 209. In embodiments and as described with FIG. 2, the remote data source 209 comprises at least one database which includes the at least one function. At step 410, the system creates, at the virtual function creation module 210, a virtual function corresponding to the at least one functional. In embodiments and as described with FIG. 2, the virtual function acts as an abstraction layer between local queries and remote data source functions.

At step 415, the system invokes, at the virtual function invoking module 214, the virtual function in response to the virtual function and data residing in a same source. In embodiments and as described with FIG. 2, the virtual function invoking module 214 translates the standard query language (SQL) query in response to the virtual function and the data residing in the same source. At step 420, the system optimizes, at the performance optimization module 214, performance of the virtual function by batching rows into arrays in a single query. In embodiments and as described with FIG. 2, the virtual function invoking module 214 optimizes performance of the virtual function by batching rows into arrays in a single query for the remote invoking in the virtual function invoking module 212. At step 425, the system outputs, at the virtual function invoking module 214, a result of the at least one function. In embodiments and as described with FIG. 2, the result of the at least one function is based on the translated SQL.

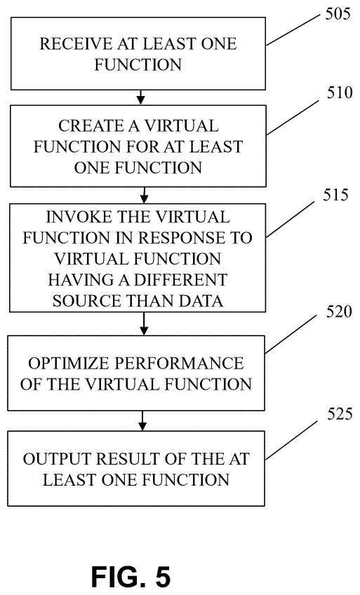

FIG. 5 shows a flowchart of an exemplary method in accordance with aspects of the present invention. Steps of the method may be carried out as operations in the environment 205 of FIG. 2 and are described with reference to elements depicted in FIG. 2.

At step 505, the system receives, at the virtual function creation module 210, at least one function from a remote data source 209. In embodiments and as described with FIG. 2, the remote data source 209 comprises at least one database which includes the at least one function. At step 510, the system creates, at the virtual function creation module 210, a virtual function corresponding to the at least one functional. In embodiments and as described with FIG. 2, the virtual function acts as an abstraction layer between local queries and remote data source functions.

At step 515, the system invokes, at the virtual function invoking module 214, the virtual function in response to the virtual function having a different source than the data. In embodiments and as described with FIG. 2, the virtual function invoking module 214 retrieves data from the standard query language (SQL), query and passes the retrieved data as input parameters to a company database of the virtual function, and returns a result of the at least one function associated with the company database in response to the virtual function having a different source than the data. At step 520, the system optimizes, at the performance optimization module 214, performance of the virtual function by batching rows into arrays in a single query. In embodiments and as described with FIG. 2, the virtual function invoking module 214 optimizes performance of the virtual function by batching rows into arrays in a single query for the remote invoking in the virtual function invoking module 212. At step 525, the system outputs, at the virtual function invoking module 214, a result of the at least one function.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, at least one function of a remote data source;
creating, by the processor set, a virtual function for the at least one function;
invoking, by the processor set, the virtual function to determine a result of the at least one function in response to the virtual function having a different source than a source of input data;
optimizing, by the processor set, performance of the virtual function; and
outputting, by the processor set, the result of the at least one function.

2. The computer-implemented method of claim 1, wherein the virtual function acts as an abstraction layer between local queries and remote data source functions.

3. The computer-implemented method of claim 1, wherein the invoking the virtual function in response to the virtual function having the different source than a source of input data comprises:
retrieving the data from a standard query language (SQL) query;
passing the retrieved data as input parameters to a first database of the virtual function; and
returning the result of the at least one function associated with the first database.

4. The computer-implemented method of claim 1, wherein the optimizing the performance of the virtual function comprises batching rows into arrays of values in a single query for the invoking the virtual function.

5. The computer-implemented method of claim 4, wherein the single query reduces network overhead of invoking the virtual function.

6. The computer-implemented method of claim 4, further comprising configuring, by the processor set, a buffer size of a data block to determine how many rows to batch at once for the arrays of values.

7. The computer-implemented method of claim 6, wherein the buffer size of the data block is configured by an administrator.

8. The computer-implemented method of claim 6, wherein the buffer size of the data is automatically configured based on system resources and business performance requirements.

9. The computer-implemented method of claim 1, wherein the virtual function is mapped to a first database function and the data resides in a second database.

10. The computer-implemented method of claim 1, further comprising aggregating, by the processor set, the result of the at least one function with the input data.

11. The computer-implemented method of claim 10, further comprising, sending, by the processor set, the aggregated result of the at least one function with the data to a user.

12. A computer program product comprising:
one or more computer readable storage media; and
program instructions stored on the one or more computer readable storage media to perform operations comprising:
receiving at least one function of a remote data source;
creating a virtual function for the at least one function;
invoking the virtual function to determine a result of the at least one function in response to the virtual function having a different source than a source of input data;
optimizing performance of the virtual function; and
outputting the result of the at least one function.

13. The computer program product of claim 12, wherein the virtual function acts as an abstraction layer between local queries and remote data source functions.

14. The computer program product of claim 12, wherein the invoking the virtual function in response to the virtual function having the different source than a source of input data comprises:
retrieving the data from a standard query language (SQL) query;
passing the retrieved data as input parameters to a first database of the virtual function; and
returning the result of the at least one function associated with the first database.

15. The computer program product of claim 12, wherein the optimizing the performance of the virtual function comprises batching rows into arrays of values in a single query for the invoking the virtual function.

16. The computer program product of claim 15, wherein the single query reduces network overhead of invoking the virtual function.

17. The computer program product of claim 15, wherein the operations further comprise configuring a buffer size of a data block to determine how many rows to batch at once for the arrays of values.

18. The computer program product of claim 12, wherein the virtual function is mapped to a first database function and the data resides in a second database.

19. The computer program product of claim 18, wherein the operations further comprise aggregating the result of the at least one function with the input data.

20. A system comprising:
a processor set;
one or more computer readable storage media; and
program instructions stored on the one or more computer readable storage media to cause the processor set to perform operations comprising:
receiving at least one function of a remote data source;
creating a virtual function for the at least one function;
invoking the virtual function to determine a result of the at least one function in response to the virtual function having a different source than a source of input data;
optimizing performance of the virtual function; and
outputting the result of the at least one function,
wherein the virtual function is mapped to a first database function and the data resides in a second database.
